(19) United States
(12) Patent Application Publication
(10) Pub. No.: US 2017/0222440 A1
(43) Pub. Date: Aug. 3, 2017

(54) Photovoltaic System

(71) Applicant: Huawei Technologies Co., Ltd., Shenzhen (CN)

(72) Inventors: Lei Shi, Shanghai (CN); Fei Ye, Shanghai (CN); Yunfeng Liu, Shanghai (CN)

(21) Appl. No.: 15/493,370

(22) Filed: Apr. 21, 2017

Related U.S. Application Data
(63) Continuation of application No. PCT/CN2015/086244, filed on Aug. 6, 2015.

(30) Foreign Application Priority Data
Jan. 4, 2015 (CN) 201510003630.9

(51) Int. Cl. H02J 3/38; H02M 7/44; H02M 1/084; H02M 3/04

(52) U.S. Cl. CPC H02J 3/383; H02M 3/04; H02M 7/44; H02M 1/084; H02M 2001/0009

(57) ABSTRACT

A photovoltaic system including multiple photovoltaic cell strings, a converter, a controller, and a bus is presented. The multiple photovoltaic cell strings include at least one string group in which parallel-connected photovoltaic cell strings are coupled to one current sensor, where the at least one string group, after being connected in parallel, is coupled to the converter using the bus, the current sensor is configured to detect a total current of each string group, the controller is configured to adjust, when receiving a report from the current sensor that a reverse current exists in a target string group in the at least one string group, a control signal output to the converter, and the converter is configured to decrease, according to an adjusted control signal, a system voltage between the buses to decrease the reverse current in the target string group.

### CROSS-REFERENCE TO RELATED APPLICATIONS

This application is a continuation of International Application No. PCT/CN2015/086244, filed on Aug. 6, 2015, which claims priority to Chinese Patent Application No. 201510003630.9, filed on Jan. 4, 2015. The disclosures of the aforementioned applications are hereby incorporated by reference in their entireties.

### TECHNICAL FIELD

The present application relates to the field of electronic technologies, and in particular, to a photovoltaic system.

### BACKGROUND

In an application scenario of a photovoltaic inverter, photovoltaic cells are connected in series or in parallel to provide an output voltage and an output current for a load. However, if one photovoltaic cell string is short-circuited, other photovoltaic cell strings may be caused to feed a reverse current to the short-circuited photovoltaic cell string. If the reverse current is higher than a short circuit current of a photovoltaic cell, it may be caused that the faulty photovoltaic cell string is burned, or in a severe case, a fire hazard may occur. Therefore, for a photovoltaic cell string, a corresponding protective measure needs to be added to prevent occurrence of a major accident.

In a solution of the prior art, each photovoltaic cell string is connected to a current sensor, and each current sensor detects a current of each photovoltaic cell string in real time. When a current sensor detects that a reverse current exists in a photovoltaic cell string, the current sensor reports the reverse current to a controller, and the controller controls a converter to decrease the reverse current of the photovoltaic cell string to protect photovoltaic cells. However, in the technical solution, each photovoltaic cell string needs to be connected to a current sensor, resulting in an increase of a device cost.

### SUMMARY

The present application provides a photovoltaic system, which can not only provide photovoltaic cell protection, but also decrease a device cost.

A first aspect of the present application provides a photovoltaic system, including multiple photovoltaic cell strings, a converter, a controller, and a bus, where the multiple photovoltaic cell strings include at least one string group in which two or three parallel-connected photovoltaic cell strings are connected to one current sensor, where the at least one string group, after being connected in parallel, is connected to the converter using the bus, the converter is connected to the controller, and the controller is connected to a current sensor in each string group in the at least one string group, the current sensor is configured to detect a total current of each string group, and report whether a reverse current exists in each string group to the controller, the controller is configured to adjust, when receiving a report from the current sensor that a reverse current exists in a target string group in the at least one string group, a control signal output to the converter, and the converter is configured to decrease, according to the adjusted control signal, a system voltage between the buses to decrease the reverse current in the target string group.

In a first possible implementation manner of the first aspect, the multiple photovoltaic cell strings further include a string group in which one photovoltaic cell string is connected to one current sensor, where the string group in which one photovoltaic cell string is connected to one current sensor and the at least one string group in which two or three parallel-connected photovoltaic cell strings are connected to one current sensor, after being connected in parallel, are connected to the converter using the bus, and the current sensor in the string group in which one photovoltaic string is connected to one current sensor is connected to the controller.

In a second possible implementation manner of the first aspect, the converter includes a switching transistor, a first capacitor, an inductor, and a first diode, where one end of the inductor is connected to an input end of the converter, the other end of the inductor is connected to both a collector of the switching transistor and a positive electrode of the first diode, a negative electrode of the first diode is connected to one end of the first capacitor, and the other end of the first capacitor is connected to both an emitter of the switching transistor and an output end of the converter.

In a third possible implementation manner of the first aspect, the controller includes a processor and a driver, where the processor is configured to determine whether the reverse current in the target string group is higher than the preset threshold; and the driver is connected to the processor, and configured to adjust, when the processor determines that the reverse current in the target string group is higher than the preset threshold, the control signal output to the converter.

With reference to the third possible implementation manner of the first aspect, in a fourth possible implementation manner of the first aspect, the controller further includes an analog to digital converter, where the analog to digital converter is connected to the processor, and configured to convert an analog signal of the reverse current reported by the current sensor into a digital signal of the reverse current, and output the digital signal of the reverse current to the processor.

With reference to the second possible implementation manner of the first aspect, in a fifth possible implementation manner of the first aspect, the converter further includes a second capacitor, where one end of the second capacitor is connected to one end of the inductor, the other end of the second capacitor is connected to the emitter of the switching transistor, and the second capacitor is configured to perform filtering processing on the input voltage.

In an embodiment of the present application, a photovoltaic system includes multiple photovoltaic cell strings, a converter, a controller, and a bus, where the multiple photovoltaic cell strings include at least one string group in which two or three parallel-connected photovoltaic cell strings are connected to one current sensor, where the at least one string group, after being connected in parallel, is connected to the converter using the bus, the converter is connected to the controller, and the controller is connected to a current sensor in each string group in the at least one string group, where the current sensor is configured to detect a total current of each string group, and report whether a reverse current exists in each string group to the controller, the controller is configured to adjust, when receiving a report from the current sensor that a reverse current exists in a target string group in the at least one string group, a control signal output to the converter, and the converter is configured to decrease, according to an adjusted control signal, a system voltage between the buses to decrease the reverse current in the target string group. Therefore, not only photovoltaic cell protection can be provided, but also a device cost is decreased.

### BRIEF DESCRIPTION OF DRAWINGS

To describe the technical solutions in the embodiments of the present application more clearly, the following briefly introduces the accompanying drawings required for describing the embodiments. The accompanying drawings in the following description show some embodiments of the present application, and a person of ordinary skill in the art may still derive other drawings from these accompanying drawings without creative efforts.

FIG. 1 is a schematic structural diagram of a photovoltaic system according to an embodiment of the present application;

FIG. 2 is a schematic structural diagram of a converter in a photovoltaic system according to an embodiment of the present application;

FIG. 3 is a schematic structural diagram of a controller in a photovoltaic system according to an embodiment of the present application; and

FIG. 4 is a V-I curve chart in working of photovoltaic cell strings.

### DESCRIPTION OF EMBODIMENTS

The following clearly describes the technical solutions in the embodiments of the present application with reference to the accompanying drawings in the embodiments of the present application. The described embodiments are some but not all of the embodiments of the present application. All other embodiments obtained by a person of ordinary skill in the art based on the embodiments of the present application without creative efforts shall fall within the protection scope of the present application.

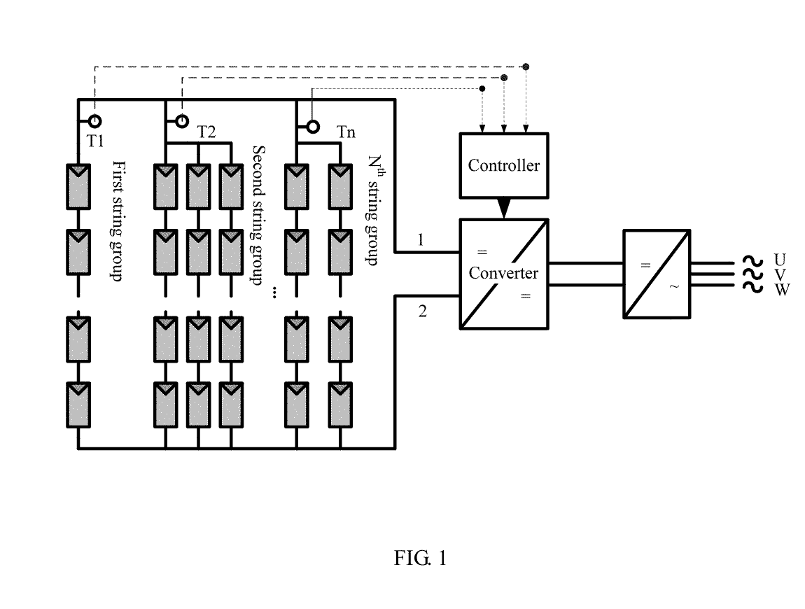

Referring to FIG. 1, FIG. 1 is a schematic structural diagram of a photovoltaic system according to an embodiment of the present application. As shown in FIG. 1, the photovoltaic system includes multiple photovoltaic cell strings, a converter, a controller, and a bus, where the multiple photovoltaic cell strings include at least one string group in which two or three parallel-connected photovoltaic cell strings are connected to one current sensor, where the at least one string group, after being connected in parallel, is connected to the converter using buses (1, 2), the converter is connected to the controller, and the controller is connected to a current sensor in each string group in the at least one string group, the current sensor is configured to detect a total current of each string group, and report whether a reverse current exists in each string group to the controller, the controller is configured to adjust, when receiving a report from the current sensor that a reverse current exists in a target string group in the at least one string group, a control signal output to the converter, and the converter is configured to decrease, according to the adjusted control signal, a system voltage between the buses (1, 2) to decrease the reverse current in the target string group.

Optionally, the multiple photovoltaic cell strings further include a string group in which one photovoltaic cell string is connected to one current sensor, where the string group in which one photovoltaic cell string is connected to one current sensor and the at least one string group in which two or three parallel-connected photovoltaic cell strings are connected to one current sensor, after being connected in parallel, are connected to the converter using the buses (1, 2), and the current sensor in the string group in which one photovoltaic string is connected to one current sensor is connected to the controller.

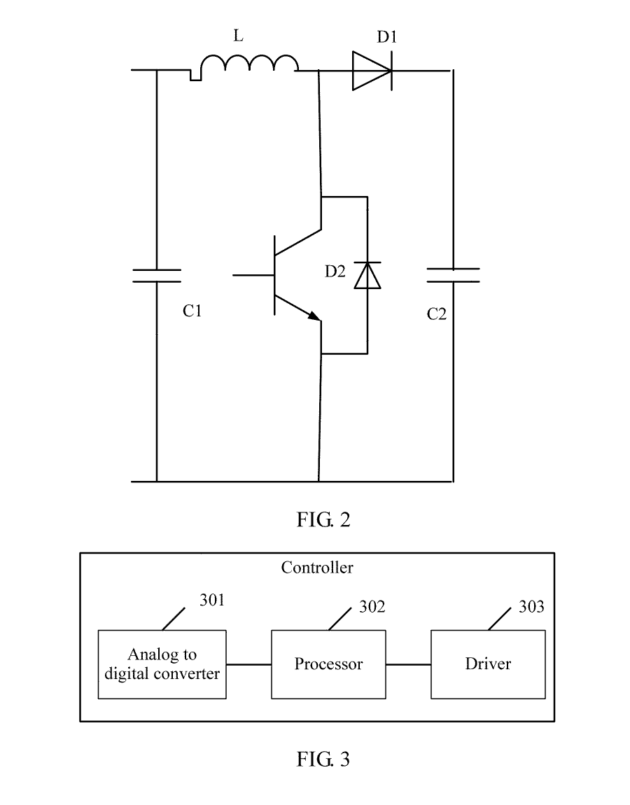

Optionally, as shown in FIG. 2, the converter includes a switching transistor, a first capacitor C1, an inductor L, and a first diode D1, where one end of the inductor L is connected to an input end of the converter, the other end of the inductor L is connected to both a collector of the switching transistor and a positive electrode of the first diode D1, a negative electrode of the first diode D1 is connected to one end of the first capacitor C1, and the other end of the first capacitor C1 is connected to both an emitter of the switching transistor and an output end of the converter.

Further, optionally, the converter includes a second capacitor C2, where one end of the second capacitor C2 is connected to one end of the inductor L, the other end of the second capacitor C2 is connected to the emitter of the switching transistor, and the second capacitor C2 is configured to perform filtering processing on an input voltage.

Optionally, as shown in FIG. 3, the controller includes a processor 302 and a driver 303.

The processor 302 is configured to determine whether the reverse current in the target string group is higher than the preset threshold.

The driver 303 is connected to the processor 302, and configured to adjust, when the processor determines that the reverse current in the target string group is higher than the preset threshold, the control signal output to the converter.

Further, optionally, the controller includes an analog to digital converter 301, where the analog to digital converter 301 is connected to the processor 302, and configured to convert an analog signal of the reverse current reported by the current sensor into a digital signal of the reverse current, and output the digital signal of the reverse current to the processor.

In this embodiment of the present application, when the string group in which the reverse current exists includes one photovoltaic cell string, the controller adjusts the control signal output to the converter, and the converter decreases, according to the adjusted control signal, the system voltage between the buses (1, 2), to decrease the reverse current of the string group to lower than a short circuit current of a photovoltaic cell. When the string group in which the reverse current exists includes two or more photovoltaic cell strings, the controller adjusts the control signal output to the converter, and the converter decreases, according to the adjusted control signal, the system voltage between the buses (1, 2), to decrease the reverse current of the string group to 0.

For example, as shown in FIG. 1, the photovoltaic system includes n string groups, and the n string groups include m photovoltaic cell strings, where a first string group includes one photovoltaic cell string, a second string group includes three photovoltaic cell strings, and an n^{th} string group includes two photovoltaic cell strings. When a photovoltaic cell string 1 in the first string group is short-circuited, output currents of a photovoltaic cell string 2 to a photovoltaic cell string m are all a maximum current value I_{sc}, causing the photovoltaic cell string 2 to the photovoltaic cell string m to feed a reverse current (m−1) I_{sc} to the photovoltaic cell string 1, and a current sensor T1 detects that the reverse current exists in the first string group and that a current value of the reverse current is (m−1) I_{sc}. Alternatively, when a photovoltaic cell string 1 in the second string group is short-circuited, output currents of a photovoltaic cell string 2 to a photovoltaic cell string m are all a maximum current value I_{sc}, causing the photovoltaic cell string 2 to the photovoltaic cell string m to feed a reverse current (m−1) I_{sc} to the photovoltaic cell string 1, and in this case, a current sensor T2 detects that the reverse current exists in the second string group and that a current value of the reverse current is (m−3) I_{sc}. Alternatively, when a photovoltaic cell string 1 in the n^{th} string group is short-circuited, output currents of a photovoltaic cell string 2 to a photovoltaic cell string m are all a maximum current value I_{sc}, causing the photovoltaic cell string 2 to the photovoltaic cell string m to feed a reverse current (m−1) I_{sc} to the photovoltaic cell string 1, and in this case, a current sensor Tn detects that the reverse current exists in the second string group and that a current value of the reverse current is (m−2) I_{sc}.

In this case, the current sensor reports the reverse current to the controller. When the controller determines that the reverse current is higher than a preset threshold, the controller increases an output time of a high electrical level in each switching cycle to increase a duty cycle D of a control signal, and outputs, to the converter, the control signal whose duty cycle is increased. As shown in FIG. 2, the converter is a switching direct current boost circuit. The switching direct current boost circuit controls turn-on of the switching transistor by controlling the duty cycle of the input control signal, so as to control an output voltage. In the switching direct current boost circuit, a relationship between an output voltage νₒᵤₜ and an input voltage νᵢₙ is

$$\frac{{v}_{out}}{{v}_{in}} = \frac{1}{1 - D} .$$

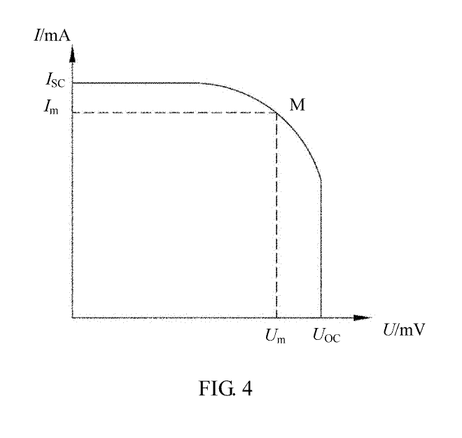

A case in which a load is controlled to keep outputting a constant voltage νₒᵤₜ, an input voltage νᵢₙ provided by a cell group string circuit may be decreased by increasing a duty cycle D of a control signal. According to a V-I curve chart, in working of photovoltaic cell strings, shown in FIG. 4, when the input voltage νᵢₙ provided by the cell group string circuit decreases, an output current of the cell group string circuit increases, and in this case, output currents of the photovoltaic cell string 2 to the photovoltaic cell string m are all the maximum current value I_{sc}, and a forward current of the photovoltaic cell string 1 increases, causing the reverse current of the photovoltaic cell string 1 to decrease, until the reverse current of the photovoltaic cell string 1 is lower than the short circuit current of the photovoltaic cell or is 0, thereby protecting the photovoltaic cell string.

In this embodiment of the present application, a photovoltaic system includes multiple photovoltaic cell strings, a converter, a controller, and a bus, where the multiple photovoltaic cell strings include at least one string group in which two or three parallel-connected photovoltaic cell strings are connected to one current sensor, where the at least one string group, after being connected in parallel, is connected to the converter using the bus, the converter is connected to the controller, and the controller is connected to a current sensor in each string group in the at least one string group, the current sensor is configured to detect a total current of each string group, and report whether a reverse current exists in each string group to the controller, the controller is configured to adjust, when receiving a report from the current sensor that a reverse current exists in a target string group in the at least one string group, a control signal output to the converter, and the converter is configured to decrease, according to an adjusted control signal, a system voltage between the buses to decrease the reverse current in the target string group. Therefore, not only photovoltaic cell protection can be provided, but also a device cost is decreased.

It should be noted that, for brief description, the foregoing device embodiments are represented as a series of actions. However, a person skilled in the art should appreciate that the present application is not limited to the described order of the actions, because according to the present application, some steps may be performed in other orders or simultaneously. In addition, a person skilled in the art should also understand that all the embodiments described in this specification belong to exemplary embodiments, and the involved actions and modules are not necessarily mandatory to the present application.

In the foregoing embodiments, the description of each embodiment has respective focuses. For a part that is not described in detail in an embodiment, reference may be made to related descriptions in other embodiments.

A person of ordinary skill in the art may understand that all or a part of the steps of the methods in the embodiments may be implemented by a program instructing relevant hardware. The program may be stored in a computer-readable storage medium. The storage medium may include a flash memory, a read-only memory (ROM), a random access memory (RAM), a magnetic disk, and an optical disc.

A content downloading method, a related device, and a system provided by the embodiments of the present application are described in detail above. Although the principles and implementation manners of the present application are described using specific examples, the description of the embodiments is only intended to help understand the method and core idea of the present application. In addition, with respect to the specific implementation manners and application scopes, modifications and variations may be made by a person of ordinary skill in the art according to the idea of the present application. Therefore, content of the specification shall not be construed as a limitation on the present application.

What is claimed is:

1. A photovoltaic system, comprising:
multiple photovoltaic cell strings comprising at least one string group in which a plurality of parallel-connected photovoltaic cell strings are coupled to one current sensor;
a converter coupled to a current sensor in each string group in the at least one string group;
a controller connecting to the converter; and
buses coupled to the converter, the controller, and the at least one string group,
wherein the at least one string group is connected in parallel with each other,
wherein the current sensor is configured to:
detect a total current of each string group; and
report whether a reverse current exists in each string group to the controller,
wherein the controller is configured to adjust a control signal output to the converter when receiving a report from the current sensor that a reverse current exists in a target string group in the at least one string group, and
wherein the converter is configured to decrease, according to the adjusted control signal, a system voltage between the buses to decrease the reverse current in the target string group.

2. The photovoltaic system according to claim 1, wherein the multiple photovoltaic cell strings further comprise a string group in which one photovoltaic cell string is coupled to one current sensor, wherein the string group in which the one photovoltaic cell string is coupled to the one current sensor and the at least one string group in which two or three parallel-connected photovoltaic cell strings are coupled to one current sensor are connected using the bus, and wherein the current sensor in the string group in which one photovoltaic string is coupled to one current sensor is coupled to the controller.

3. The photovoltaic system according to claim 1, wherein the converter comprises a switching transistor, a first capacitor, an inductor, and a first diode, wherein one end of the inductor is coupled to an input end of the converter, wherein another end of the inductor is coupled to both a collector of the switching transistor and a positive electrode of the first diode, wherein a negative electrode of the first diode is coupled to one end of the first capacitor, and wherein another end of the first capacitor is coupled to both an emitter of the switching transistor and an output end of the converter.

4. The photovoltaic system according to claim 1, wherein the controller comprises:
a processor configured to determine whether the reverse current in the target string group is higher than a preset threshold; and
a driver coupled to the processor and configured to adjust the control signal output to the converter when the processor determines that the reverse current in the target string group is higher than the preset threshold.

5. The photovoltaic system according to claim 4, wherein the controller further comprises an analog to digital converter coupled to the processor and configured to:
convert an analog signal of the reverse current reported by the current sensor into a digital signal of the reverse current; and
output the digital signal of the reverse current to the processor.

6. The photovoltaic system according to claim 3, wherein the converter further comprises a second capacitor, wherein one end of the second capacitor is coupled to one end of the inductor, wherein another end of the second capacitor is coupled to the emitter of the switching transistor, and wherein the second capacitor is configured to perform filtering processing on an input voltage.

7. A photovoltaic system, comprising:
multiple photovoltaic cell strings comprising at least one string group in which two parallel-connected photovoltaic cell strings are coupled to one current sensor;
a converter coupled to a current sensor in each string group in the at least one string group;
a controller connecting to the converter; and
buses coupled to the converter, the controller, and the at least one string group,
wherein the at least one string group is connected in parallel to each other,
wherein the current sensor is configured to detect a total current of each string group,
wherein the controller is configured to adjust a control signal output to the converter when a reverse current is detected in a target string group in the at least one string group, and
wherein the converter is configured to decrease, according to the adjusted control signal, a system voltage between the buses to decrease the reverse current in the target string group.

8. The photovoltaic system according to claim 7, wherein the multiple photovoltaic cell strings further comprise a string group in which one photovoltaic cell string is coupled to one current sensor, wherein the string group in which the one photovoltaic cell string is coupled to the one current sensor and the at least one string group in which two or three parallel-connected photovoltaic cell strings are coupled to one current sensor, after being connected in parallel, are coupled to the converter using the bus, and wherein the current sensor in the string group in which one photovoltaic string is coupled to one current sensor is coupled to the controller.

9. The photovoltaic system according to claim 8, wherein the converter comprises a switching transistor, a first capacitor, an inductor, and a first diode, wherein one end of the inductor is coupled to an input end of the converter, wherein another end of the inductor is coupled to both a collector of the switching transistor and a positive electrode of the first diode, wherein a negative electrode of the first diode is coupled to one end of the first capacitor, and wherein another end of the first capacitor is coupled to both an emitter of the switching transistor and an output end of the converter.

10. The photovoltaic system according to claim 7, wherein the controller comprises:
a processor configured to determine whether the reverse current in the target string group is higher than a preset threshold; and
a driver coupled to the processor and configured to adjust the control signal output to the converter when the processor determines that the reverse current in the target string group is higher than the preset threshold.

11. The photovoltaic system according to claim 10, wherein the controller further comprises an analog to digital converter, wherein the analog to digital converter is coupled to the processor and configured to:
convert an analog signal of the reverse current reported by the current sensor into a digital signal of the reverse current; and
output the digital signal of the reverse current to the processor.

12. The photovoltaic system according to claim 9, wherein the converter further comprises a second capacitor, wherein one end of the second capacitor is coupled to one end of the inductor, wherein another end of the second capacitor is coupled to the emitter of the switching transistor, and wherein the second capacitor is configured to perform filtering processing on an input voltage.

13. A photovoltaic system, comprising:
multiple photovoltaic cell strings comprising at least one string group in which three parallel-connected photovoltaic cell strings are coupled to one current sensor;
a converter coupled to a current sensor in each string group in the at least one string group;
a controller connecting to the converter; and
buses coupled to the converter, the controller, and the at least one string group,
wherein the at least one string group is connected in parallel with each other,
wherein the current sensor is configured to:
detect a total current of each string group; and
report whether a reverse current exists in each string group to the controller,
wherein the controller is configured to adjust a control signal output to the converter when receiving a report from the current sensor that a reverse current exists in a target string group in the at least one string group, and
wherein the converter is configured to decrease, according to the adjusted control signal, a system voltage between the buses to decrease the reverse current in the target string group.

14. The photovoltaic system according to claim 13, wherein the multiple photovoltaic cell strings further comprise a string group in which one photovoltaic cell string is coupled to one current sensor, wherein the string group in which the one photovoltaic cell string is coupled to the one current sensor and the at least one string group in which two or three parallel-connected photovoltaic cell strings are coupled to one current sensor are connected using the bus, and wherein the current sensor in the string group in which one photovoltaic string is coupled to one current sensor is coupled to the controller.

15. The photovoltaic system according to claim 13, wherein the converter comprises a switching transistor, a first capacitor, an inductor, and a first diode, wherein one end of the inductor is coupled to an input end of the converter, wherein another end of the inductor is coupled to both a collector of the switching transistor and a positive electrode of the first diode, wherein a negative electrode of the first diode is coupled to one end of the first capacitor, and wherein another end of the first capacitor is coupled to both an emitter of the switching transistor and an output end of the converter.

16. The photovoltaic system according to claim 13, wherein the controller comprises:
a processor configured to determine whether the reverse current in the target string group is higher than a preset threshold; and
a driver coupled to the processor and configured to adjust the control signal output to the converter when the processor determines that the reverse current in the target string group is higher than the preset threshold.

17. The photovoltaic system according to claim 16, wherein the controller further comprises an analog to digital converter coupled to the processor and configured to:
convert an analog signal of the reverse current reported by the current sensor into a digital signal of the reverse current; and
output the digital signal of the reverse current to the processor.

18. The photovoltaic system according to claim 15, wherein the converter further comprises a second capacitor, wherein one end of the second capacitor is coupled to one end of the inductor, wherein another end of the second capacitor is coupled to the emitter of the switching transistor, and wherein the second capacitor is configured to perform filtering processing on an input voltage.
